(19) United States
(12) Patent Application Publication
(10) Pub. No.: US 2020/0238949 A1
(43) Pub. Date: Jul. 30, 2020

(54) SEAT BELT RETRACTOR AND SEAT BELT DEVICE

(71) Applicant: TAKATA CORPORATION, Tokyo (JP)

(72) Inventor: Takashi SAKANO, Echi-gun, Shiga (JP)

(73) Assignee: TAKATA CORPORATION, Tokyo (JP)

(21) Appl. No.: 15/768,882

(22) PCT Filed: Oct. 14, 2016
(86) PCT No.: PCT/JP2016/080460

§ 371 Date: Apr. 17, 2018

(30) Foreign Application Priority Data
Oct. 21, 2015 (JP) 2015-207575

(51) Int. Cl. B60R 22/46

(52) U.S. Cl. CPC B60R 22/4671; B60R 2022/468

(57) ABSTRACT

Provided are a seat belt retractor and a seat belt device capable of stably supplying components and avoiding an increase in cost even when an injection body made of resin is used.

A spool 2 which winds up webbing which restrains an occupant, a base frame 3 which accommodates the spool 2 so as to be rotatable, a spring unit 4 which biases the spool 2 in a winding direction, a pretensioner 5 capable of winding up the webbing in an emergency, and a lock mechanism 6 capable of stopping withdrawal of the webbing are provided, the pretensioner 5 including a rotating body 51 concentrically connected to the spool 2 and an injection body 52a made of resin which rotates the rotating body 51, the rotating body 51 made of metal having a wall thickness T half a diameter D of the injection body 52a or smaller.

### TECHNICAL FIELD

The present invention relates to a seat belt retractor and a seat belt device, and especially relates to a seat belt retractor and a seat belt device suitable for a method of winding up webbing by using an injection body made of resin in an emergency.

### BACKGROUND ART

A vehicle such as an automobile is provided with a seat belt device which restrains an occupant on a seat provided with a seat portion on which the occupant is seated and a backrest portion located on a back side of the occupant. Such seat belt device includes webbing which restrains an occupant, a seat belt retractor which winds up the webbing, a guide anchor provided on a vehicle body side which guides the webbing, a belt anchor which fixes the webbing to the vehicle body side, a buckle arranged on a side surface of the seat, and a tong arranged on the webbing, and restrains the occupant on the seat by the webbing by fitting the tong to the buckle. In such seat belt device, a first end of the webbing is fixed to the belt anchor and a second end of the webbing is inserted through the guide anchor to be connected to the seat belt retractor.

Such seat belt retractor generally includes a lock mechanism which stops withdrawal of the webbing when the vehicle is inclined or suddenly decelerated at the time of collision of the vehicle or the like and a pretensioner which removes slack of the webbing at the time of collision of the vehicle or the like (refer to, for example, Patent Literatures 1 and 2).

As an injection body of the pretensioner, a ball type made of metal as disclosed in Patent Literature 1 is conventionally widely used; in recent years, a rod (rack) type made of resin as disclosed in Patent Literature 2 is also used.

### CITATION LIST

### Patent Literature

Patent Literature 1: JP 2014-80121 A

Patent Literature 2: JP 2014-201154 A

### SUMMARY OF INVENTION

### Technical Problem

As disclosed in Patent Literature 2, when an injection body made of resin is used, a rotating member (also referred to as a pinion or a paddle wheel) engaging with such injection body should be prevented from being damaged by a high-speed injection body, so that this is formed of hard metal such as iron to be thick. For example, in the invention disclosed in Patent Literature 2, a wall thickness of the rotating member (pinion) is made substantially the same as a diameter of the injection body.

However, it is generally difficult to perform press work on such thick metallic component with high accuracy, and it is difficult to stably supply the rotating member. In addition, when the rotating member is a sintered body, this may be stably supplied, but there is a problem that a manufacturing cost raises.

The present invention is achieved in view of the above-described problems, and an object thereof is to provide a seat belt retractor and a seat belt device capable of stably supplying components and avoiding an increase in cost even when the injection body made of resin is used.

### Solution to Problem

According to the present invention, there is provided a seat belt retractor provided with a spool which winds up webbing which restrains an occupant, a pretensioner capable of winding up the webbing in an emergency, and a lock mechanism capable of stopping withdrawal of the webbing, in which the pretensioner includes a rotating body concentrically connected to the spool and an injection body made of resin which rotates the rotating body, and the rotating body is made of metal and has a wall thickness half a diameter of the injection body or smaller.

Also, according to the present invention, there is provided a seat belt device provided with webbing which restrains an occupant, a seat belt retractor which winds up the webbing, a belt anchor which fixes the webbing to a vehicle body side, a buckle arranged on a side surface of the seat, and a tong arranged on the webbing, in which the seat belt retractor is provided with a spool which winds up the webbing, a pretensioner capable of winding up the webbing in an emergency, and a lock mechanism capable of stopping withdrawal of the webbing, in which the pretensioner includes a rotating body concentrically connected to the spool and an injection body made of resin which rotates the rotating body, and the rotating body is made of metal and has a wall thickness half a diameter of the injection body or smaller.

In the above-described seat belt retractor and seat belt device, a material of the rotating body is metal containing iron or an alloy thereof, for example.

Also, the spool may include a locking base coupled to the lock mechanism, the rotating body may be arranged between the spool and the locking base, and the spool, the locking base, or both of the spool and the locking base may include an auxiliary engaging tooth which assists the rotation of the rotating body. Furthermore, the spool and the locking base may be die cast products.

Also, the spool may include a locking base coupled to the lock mechanism, the rotating body may be arranged between the spool and the locking base, one of the spool and the locking base may include an auxiliary engaging tooth which assists the rotation of the rotating body, the other of the spool and the locking base may include a pathway of the injection body, and a lubricant may be applied to a surface of the pathway.

The spool may include a locking base coupled to the lock mechanism, the rotating body may be arranged between the spool and the locking base and include a plurality of engaging teeth formed along an outer periphery, and the engaging teeth may be inclined toward the spool side or the locking base side.

Also, the spool may include a deformation pin configured to be plastically deformable at the time of rotation when the lock mechanism is in operation, and a head portion of the deformation pin may be locked on the rotating body.

### Advantageous Effects of Invention

According to the seat belt retractor and the seat belt device according to the present invention described above, the rotating body rotated by the injection body made of resin is formed of the metallic material to have the wall thickness half the diameter of the injection body, so that it is possible to suppress the wall thickness of the rotating body within a range suitable for press molding and to stably supply the components. Also, according to the present invention, since the rotating body is press-molded, it is not necessary to form the rotating body of a sintered body, so that an increase in cost may be avoided.

### BRIEF DESCRIPTION OF DRAWINGS

FIG. 1 is a component development view illustrating a seat belt retractor according to a first embodiment of the present invention.

FIGS. 2A and 2B are explanatory views of the seat belt retractor illustrated in FIG. 1, in which FIG. 2A is a side view in a state in which a shaft unit is assembled and FIG. 2B is a comparison chart illustrating a relationship between an injection body and an engaging tooth.

FIGS. 3A and 3B are views illustrating a variation of the seat belt retractor illustrated in FIG. 1, in which FIG. 3A illustrates a first variation and FIG. 3B illustrates a second variation.

FIGS. 4A and 4B are views illustrating a seat belt retractor according to a second embodiment of the present invention, in which FIG. 4A is a component development view of a shaft unit and FIG. 4B is a side view in a state in which the shaft unit is assembled.

FIGS. 5A to 5D are views illustrating a seat belt retractor according to a third embodiment of the present invention, in which FIG. 5A is a side view of a state in which a shaft unit is assembled, FIG. 5B is a perspective view of a rotating body, FIG. 5C is a perspective view and a side view illustrating a first variation of the rotating body, and FIG. 5D is a perspective view and a side view illustrating a second variation of the rotating body.

FIG. 6 is an entire configuration diagram illustrating a seat belt device according to the embodiment of the present invention.

### DESCRIPTION OF EMBODIMENTS

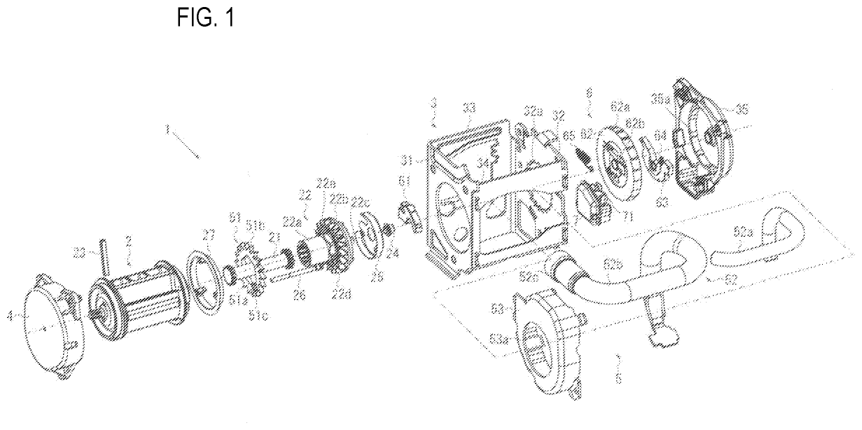

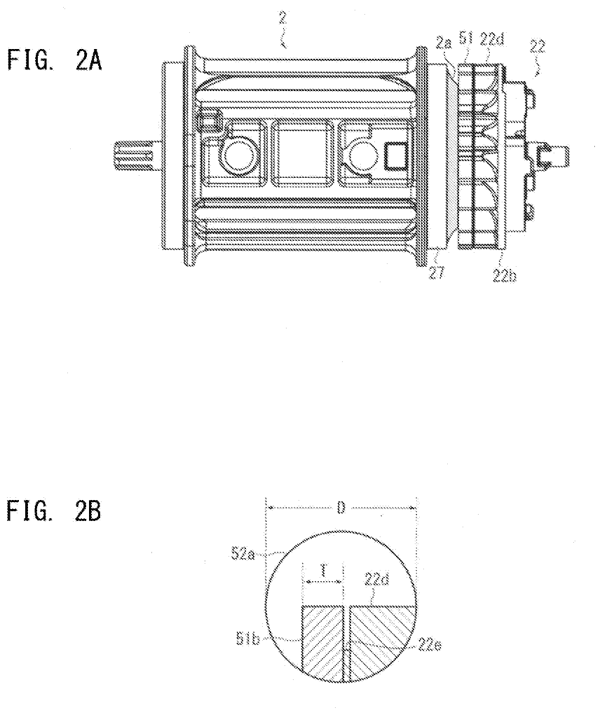

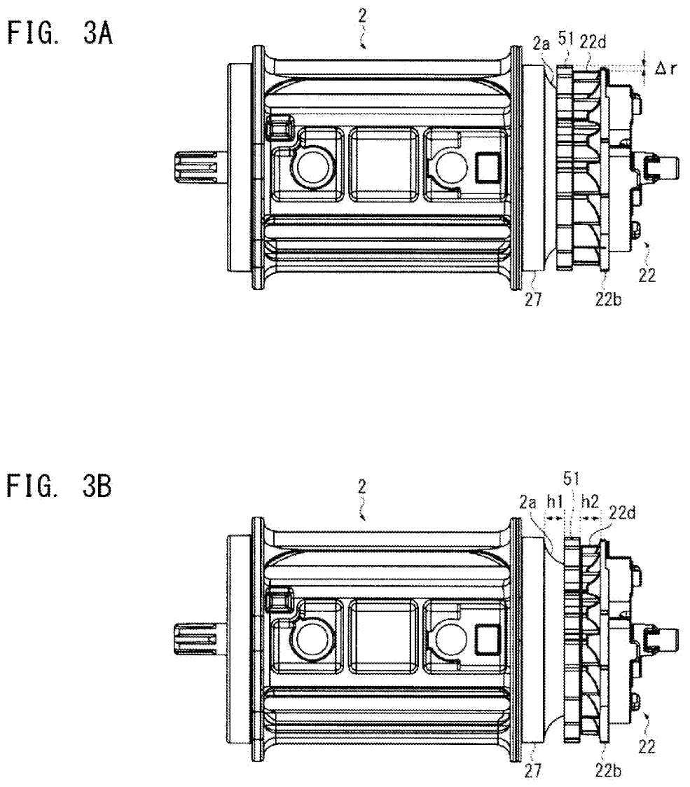

Hereinafter, embodiments of the present invention are described with reference to FIGS. 1 to 6. Herein, FIG. 1 is a component development view illustrating a seat belt retractor according to a first embodiment of the present invention. FIGS. 2A and 3B are explanatory views of the seat belt retractor illustrated in FIG. 1, in which FIG. 2A is a side view in a state in which a shaft unit is assembled, and FIG. 2B is a comparison chart illustrating a relationship between an injection body and an engaging tooth.

As illustrated in FIGS. 1 to 2B, a seat belt retractor 1 according to the first embodiment of the present invention is provided with a spool 2 which winds up webbing which restrains an occupant, a base frame 3 which accommodates the spool 2 so as to be rotatable, a spring unit 4 which biases the spool 2 in a winding direction, a pretensioner 5 capable of winding up the webbing in an emergency, and a lock mechanism 6 capable of stopping withdrawal of the webbing, the pretensioner 5 including a rotating body 51 concentrically connected to the spool 2 and an injection body 52a made of resin which rotates the rotating body 51, the rotating body 51 made of metal having a wall thickness T half a diameter D of the injection body 52a.

The spool 2 is a winding drum which winds up the webbing. A first end of the spool 2 is connected to the spring unit 4, and the spool 2 is biased in the winding direction of the webbing by a spiral spring stored in the spring unit 4. Meanwhile, a unit which applies winding force to the spool 2 is not limited to the spring unit 4, but may be another unit using an electric motor and the like.

A torsion bar 21 serving as a shaft core is inserted into a cavity formed in a central portion of the spool 2, a first end of the torsion bar 21 connected to an inner surface of the end of the spool 2 on a side to which the spring unit 4 is connected, and a second end of the torsion bar 21 connected to a locking base 22. A positioning pin 23 which prevents the torsion bar 21 from dropping may be inserted to a peripheral surface of the spool 2. Meanwhile, a configuration of an impact absorbing mechanism including the torsion bar 21 is not limited to the illustrated configuration; this may be a configuration in which the torsion bar 21 is not used or omitted as necessary.

The locking base 22 being a component coupled to the lock mechanism 6 is arranged on a second end of the spool 2. The locking base 22 is, for example, a cast product obtained by casting an alloy of aluminum, zinc and the like by die casting. The locking base 22 includes a shaft portion 22a inserted into the cavity of the spool 2 and a widened portion 22b which supports a part (for example, a pawl 61 and the like) of components forming the lock mechanism 6. A rotational shaft 22c rotatably supported by a retainer cover 35 via a cap 24 is formed on a surface of the widened portion 22b. Meanwhile, a protect cover 25 which protects at least a part of a side surface of the widened portion 22b from contact with the base frame 3 may also be arranged on a front surface side of the widened portion 22b.

Therefore, at a normal time when the pretensioner 5 and the lock mechanism 6 do not operate, the torsion bar 21 is configured to rotate integrally with the spool 2. Also, when the pretensioner 5 is in operation, the webbing may be wound around the spool 2 by rotation of the torsion bar 21. Also, when the lock mechanism 6 is in operation, the rotation of the torsion bar 21 is restricted, and the withdrawal of the webbing is suppressed by locking the rotation of the spool 2.

Furthermore, when force equal to or larger than a predetermined value acts on the webbing in a withdrawal direction, since the spool 2 is cantilevered by the torsion bar 21, it is possible to limit a load of the webbing by torsional deformation of the torsion bar 21 and absorb impact energy of the occupant.

A deformation pin 26 made of metal may also be arranged on an end face of the spool 2 on a side on which the pretensioner 5 is arranged. The deformation pin 26 having, for example, an elongated rod shape or a wire shape is inserted into a body portion of the spool 2 through a locking hole 51c formed on the rotating body 51, for example, and a head portion thereof is locked on the rotating body 51. By locking the deformation pin 26 on the rotating body 51 in this manner, it is possible to omit a deformation plate conventionally necessary, thereby reducing the number of components.

Also, by arranging such deformation pin 26, when the spool 2 rotates by the webbing withdrawn at the time of operation of the lock mechanism 6, force acts to withdraw the deformation pin 26 in a rotational direction, so that the deformation pin 26 plastically deforming by being squeezed between the spool 2 and the rotating body 51 may absorb the impact energy of the occupant. That is, in this embodiment, the spool 2 is provided with the deformation pin 26 configured to be plastically deformable at the time of rotation in the operating state of the lock mechanism 6, and the head portion of the deformation pin 26 is locked on the rotating body 51. Meanwhile, the deformation pin 26 may be omitted as necessary.

The spool 2 is, for example, a cast product obtained by casting the alloy of aluminum, zinc and the like by die casting. Since aluminum cast products have large friction against iron, a shaft bearing 27 made of resin may be arranged in a portion adjacent to an opening 53a formed on a cover member 53 of the pretensioner 5.

The base frame 3 is a casing forming a framework of the seat belt retractor 1. The base frame 3 is formed of, for example, a pair of end faces 31 and 32 facing each other, a side surface 33 connecting the end faces, and a tie plate 34 facing the side surface 33 to be connected to the end faces 31 and 32. The spring unit 4 is arranged on an outer side of the end face 31, the pretensioner 5 is arranged on an inner side of the end face 32, and the lock mechanism 6 is arranged on an outer side of the end face 32. The lock mechanism 6 is accommodated in the retainer cover 35 connected to the base frame 3.

In the retainer cover 35, a vehicle sensor 7 which detects sudden deceleration and inclination of a vehicle body may be arranged. The vehicle sensor 7 including a built-in spherical mass body and an actuator 71 swung by movement of the mass body is accommodated in a recess formed on the retainer cover 35. Such vehicle sensor 7 is configured such that the mass body moves upward when the vehicle body suddenly decelerates or inclines, and a tip end of the actuator 71 is swung upward accordingly. Due to this swinging, the actuator 71 is locked on an external tooth 62a of a lock gear 62 to be described later.

The pretensioner 5 includes the rotating body 51 connected to the end of the spool 2 via the torsion bar 21 and the locking base 22, a power generating unit 52 which rotates the rotating body 51, and the cover member 53 which accommodates the rotating body 51. The cover member 53 may be arranged on the inner side (end face 31 side) of the end face 32 of the base frame 3 or may be arranged on the outer side (retainer cover 35 side) of the end face 32 of the base frame 3.

The power generating unit 52 also includes, for example, the injection body 52a which rotates the rotating body 51, a guide pipe 52b which accommodates the injection body 52a and guides driving thereof, and a gas generating device 52c arranged on an end of the guide pipe 52b which applies power to the injection body 52a.

The injection body 52a being a rod made of resin, for example, is configured to move along a shape of the guide pipe 52b inside the guide pipe 52b when pressure is applied to an end of the injection body 52a. Meanwhile, the injection body 52a is not limited to a rod member but may be, for example, that made of a plurality of spheres made of resin or a plurality of twin balls obtained by connecting two spheres made of resin.

The rotating body 51 includes a polygonal (for example, hexagonal) opening 51a formed on a central portion thereof and a plurality of engaging teeth 51b formed along an outer periphery thereof. For example, a polygonal columnar portion (for example, a hexagonal columnar portion) formed on the shaft portion 22a of the locking base 22 is inserted into the opening 51a, and the rotating body 51 is fixed to the locking base 22. The engaging tooth 51b is engaged with the injection body 52a emitted from the guide pipe 52b, and the rotating body 51 is rotated. Meanwhile, the rotating body 51 is sometimes also referred to as a pinion or a paddle wheel.

A material of the rotating body 51 is, for example, metal containing iron or an alloy thereof (for example, stainless steel and the like), and a conventional rotating body 51 has a wall thickness substantially equal to or larger than a diameter (for example, approximately 10 mm) of the injection body 52a in general. However, it is difficult to perform press work on a metallic component having a large wall thickness (for example, 6 mm or larger) with high accuracy, and it is difficult to stably supply the rotating body 51. When the rotating body 51 is a sintered body, it is possible to stably supply the same, but a manufacturing cost thereof raises.

Therefore, in this embodiment, as illustrated in FIG. 2B, a wall thickness T of the rotating body 51 is made half the diameter D of the injection body 52a or smaller. In contrast, when the wall thickness T of the rotating body 51 is made small, there is a possibility that a pressure receiving area becomes insufficient when the injection body 52a collides with the engaging tooth 51b. Therefore, as illustrated in FIG. 1 and FIG. 2A, the locking base 22 may include an auxiliary engaging tooth 22d which assists the rotation of the rotating body 51.

The auxiliary engaging tooth 22d is arranged, for example, on a rear surface (shaft portion 22a side) of the widened portion 22b of the locking base 22. Specifically, a cylindrical or columnar support portion 22e is formed on the rear surface of the widened portion 22b concentrically with the shaft portion 22a, and the auxiliary engaging teeth 22d are formed along an outer peripheral surface thereof. The auxiliary engaging tooth 22d may be formed in the same phase as the engaging tooth 51b of the rotating body 51 or they may be formed in different phases.

By forming such auxiliary engaging tooth 22d, as illustrated in FIG. 2B, it is possible to enlarge the pressure receiving area (hatched portion) with respect to the injection body 52a. Also, as illustrated in FIG. 2B, the support portion 22e may be formed so as to protrude slightly outside the auxiliary engaging tooth 22d (toward the rotating body 51 side). With such a configuration, it is possible to form an abutment surface against the rotating body 51 on the end of the support portion 22e, thereby forming a slight gap between the engaging tooth 51b and the auxiliary engaging tooth 22d. This gap may suppress interference between the engaging tooth 51b and the auxiliary engaging tooth 22d accompanying with working accuracy of the rotating body 51. It goes without saying that the support portion 22e may be omitted if working accuracy may be secured.

A support base 2a which supports the rotating body 51 may also be formed on the end of the spool 2. For example, as illustrated in FIG. 2A, the support base 2a is formed to have a smaller diameter on a tip end side than a diameter on a base side, and the tip end having the smaller diameter forms the abutment surface against the rotating body 51. An outer peripheral surface of the support base 2a is formed of a curved surface curved so as not to interfere with the injection body 52a.

That is, a pathway of the injection body 52a is formed by the outer peripheral surface of the support base 2a. A lubricant may be applied to a surface of this pathway (a part in gray in the drawing). By applying the lubricant to the pathway of the injection body 52a, it is possible to allow the injection body 52a to smoothly pass. As the lubricant, for example, grease, wax and the like may be used. Meanwhile, although not illustrated, it is also possible to form auxiliary engaging tooth on the support base 2a of the spool 2 and form the pathway of the injection body 52a on the rear surface of the widened portion 22b of the locking base 22.

The lock mechanism 6 includes, for example, the pawl 61 arranged so as to be swingable on the surface of the locking base 22, the lock gear 62 which rotates the pawl 61 outward, and a flywheel 63 arranged in a space formed between the lock gear 62 and the retainer cover 35. An opening 32a through which the widened portion 22b of the locking base 22 may be inserted is formed on the end face 32 of the base frame 3, and an internal tooth is formed on an inner edge of the opening 32a. The pawl 61 is configured to be able to engage with the internal tooth of the opening 32a.

The lock gear 62 through which the rotational shaft 22c of the locking base 22 is inserted has an external tooth 62a formed on an outer periphery thereof. The actuator 71 of the vehicle sensor 7 is engaged with the external tooth 62a. The flywheel 63 is arranged so as to be swingable inside the external tooth 62a of the lock gear 62. A circular recess is formed on the retainer cover 35, and the internal tooth 35a is formed inside the recess. A tip end of the flywheel 63 is engaged with the internal tooth 35a when the lock mechanism 6 is in operation. Meanwhile, the flywheel 63 is biased by a hook spring 64 in such a direction that the tip end thereof separates from the internal tooth 35a.

A cam hole 62b formed so as to curve from an outer edge side toward an inner edge side is formed on a flat surface portion of the lock gear 62. A pin formed on a side surface portion of the pawl 61 is inserted into the cam hole 62b, the pin moves along the cam hole 62b as the lock gear 62 rotates relative to the locking base 22, and the pawl 61 swings. Meanwhile, the pawl 61 is biased by a pawl spring 65 in such a direction that a tip end thereof separates from the internal tooth of the opening portion 32a.

The flywheel 63 is a mass body arranged so as to be swingable between the retainer cover 35 and the lock gear 62. Biasing force of the flywheel 63 (elastic force of the hook spring 64) is set to be larger than inertial force generated in the flywheel 63 when withdrawal acceleration of the webbing is equal to or lower than a predetermined threshold, and at that time, the flywheel 63 rotates together with the lock gear 62.

On the other hand, when the withdrawal acceleration of the webbing becomes higher than a predetermined threshold, the inertial force generated in the flywheel 63 becomes larger than the biasing force (the elastic force of the hook spring 64), and the tip end of the flywheel 63 is brought closer to the internal tooth 35a of the retainer cover 35 to engage with the same.

According to the lock mechanism 6 having such a configuration, since the actuator 71, the flywheel 63, and the pawl 61 are in a non-engaged state at the normal time, the locking base 22 and the lock gear 62 may freely rotate with the rotation of the spool 2.

When the withdrawal acceleration of the webbing is higher than normal withdrawal acceleration, that is, when the withdrawal acceleration of the webbing exceeds a predetermined threshold, the flywheel 63 swings to engage with the internal tooth 35a of the retainer cover 35, and the rotation of the lock gear 62 is restricted. Also when the vehicle sensor 7 operates, the tip end of the actuator 71 is engaged with the external tooth 62a of the lock gear 62, and the rotation of the lock gear 62 is restricted.

When the rotation of the lock gear 62 is restricted in this manner, relative rotation is generated between the spool 2 (locking base 22) and the lock gear 62, the pawl 61 moves along the cam hole 62b in association with the relative rotation, and the tip end of the pawl 61 engages with the internal tooth formed on the inner edge of the opening portion 32a of the base frame 3. As a result, the rotation of the locking base 22 is restricted, and the withdrawal of the webbing is restricted.

According to the seat belt retractor 1 according to the above-described first embodiment, the rotating body 51 rotated by the injection body 52a made of resin is formed of the metallic material to have the wall thickness T half the diameter D of the injection body 52a or smaller, so that it is possible to suppress the wall thickness T of the rotating body 51 within a range suitable for press molding and to stably supply the components. In addition, according to the seat belt retractor 1 described above, since the rotating body 51 is press-molded, it is not necessary to form the rotating body 51 of a sintered body, so that an increase in cost may be avoided.

Next, a variation of the seat belt retractor 1 according to the above-described first embodiment is described. Herein, FIGS. 3A and 3B are views illustrating the variation of the seat belt retractor illustrated in FIG. 1, in which FIG. 3A illustrates a first variation and FIG. 3B illustrates a second variation. Meanwhile, the same component as that of the seat belt retractor 1 according to the first embodiment is assigned with the same reference sign and the description thereof is not repeated.

In the first variation illustrated in FIG. 3A, a diameter of an auxiliary engaging tooth 22d is made smaller than that of a rotating body 51 by Δr. A size of the auxiliary engaging tooth 22d is set according to a pressure receiving area required for an injection body 52a. At that time, it is possible to arbitrarily adjust the pressure receiving interview by changing the diameter of the auxiliary engaging tooth 22d.

In the second variation illustrated in FIG. 3B, an engaging tooth 51b of a rotating body 51 is brought into contact with substantially the center of an injection body 52a. A position of the rotating body 51 in an axial direction may be arbitrarily adjusted by changing a height h1 of a support base 2a or a height h2 of a support portion 22e.

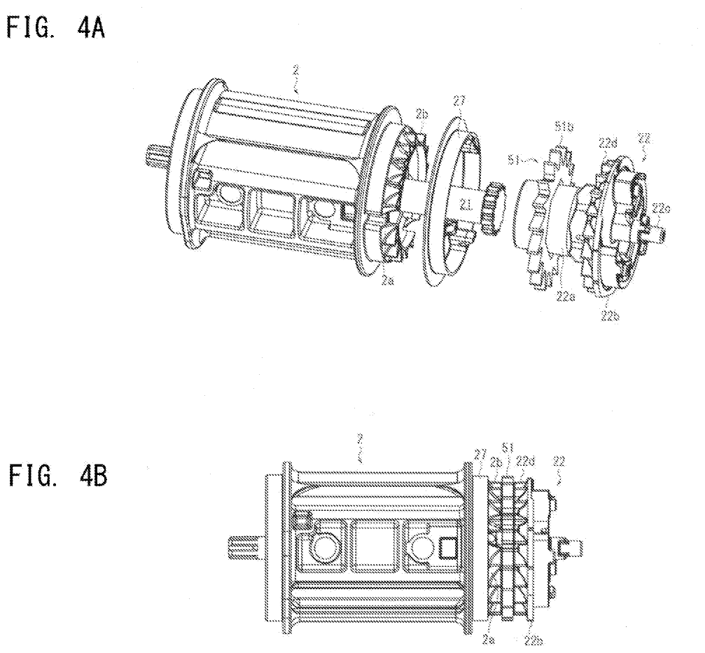

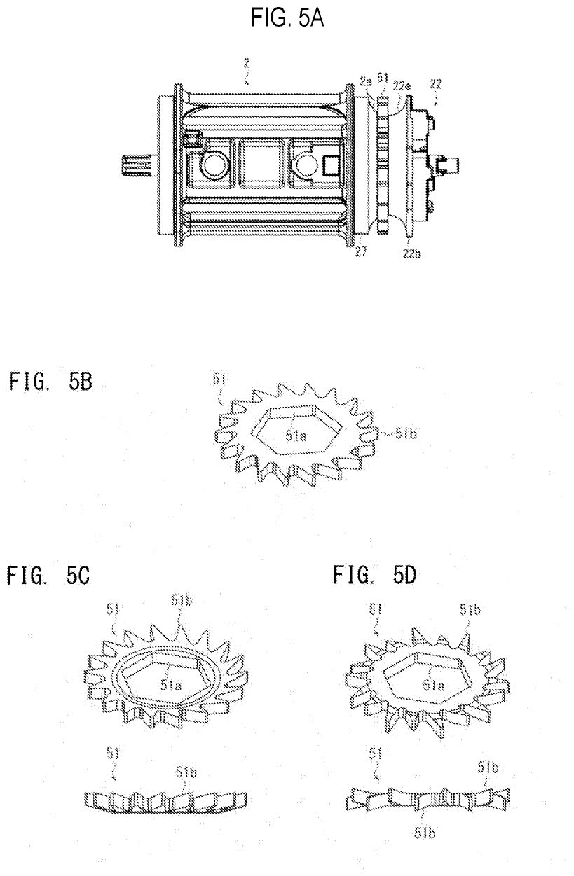

Next, a seat belt retractor 1 according to other embodiments of the present invention is described. Herein, FIGS. 4A and 4B is a view illustrating a seat belt retractor according to a second embodiment of the present invention, in which FIG. 4A is a component development view of a shaft unit and FIG. 4B is a side view in a state in which the shaft unit is assembled. FIGS. 5A to 5D are views illustrating a seat belt retractor according to a third embodiment of the present invention, in which FIG. 5A is a side view in a state in which a shaft unit is assembled, FIG. 5B is a perspective view of a rotating body, FIG. 5C is a perspective view and a side view illustrating a first variation of the rotating body, and FIG. 5D is a perspective view and a side view illustrating a second variation of the rotating body. Meanwhile, the same component as that of the seat belt retractor 1 according to the first embodiment is assigned with the same reference sign and the description thereof is not repeated.

The seat belt retractor 1 according to the second embodiment illustrated in FIGS. 4A and 4B is such that not only an auxiliary engaging tooth 22d formed on a locking base 22 but also an auxiliary engaging tooth 2b is formed on an outer peripheral surface of a support base 2a of a spool 2. Therefore, as illustrated in FIG. 4B, the auxiliary engaging tooth 22d and auxiliary engaging tooth 2b are arranged on both sides of a rotating body 51. At that time, in order to equalize loads generated on the auxiliary engaging tooth 22d and the auxiliary engaging tooth 2b, heights of the support base 2a and a support portion 22e may be adjusted such that the rotating body 51 is arranged substantially at the center of the injection body 52a. A pressure receiving area may be arbitrarily adjusted by changing diameters of the auxiliary engaging tooth 22d and the auxiliary engaging tooth 2b.

In the seat belt retractor 1 according to the third embodiment illustrated in FIGS. 5A and 5B, only the rotating body 51 is arranged with the auxiliary engaging tooth omitted. In the third embodiment, a pathway of the injection body 52a is formed by the outer peripheral surfaces of the support portion 22e and the support base 2a. Although not illustrated, a lubricant may be applied to the outer peripheral surfaces of the support portion 22e and the support base 2a. For example, as illustrated in FIG. 5B, the rotating body 51 has a shape in which an opening 51a and an engaging tooth 51b are formed on a flat plate member.

Also, as illustrated, the engaging tooth 51b of the rotating body 51 may be such that a tooth tip is inclined in a direction opposite to a rotating direction of the rotating body 51 (winding direction of webbing) so as to be easily engaged with the injection body 52a. However, a shape of the engaging tooth 51b is not limited to the illustrated configuration, and may be, for example, a tooth tip shape having symmetrical tooth surfaces like a normal gear. The shape of the engaging tooth 51b is similar in other embodiments and other variations.

Meanwhile, although not illustrated, the rotating body 51 may also be obtained by dividing a shape of a complete body into a plurality of parts by a plane perpendicular to an axial direction, thereby preparing divided bodies having a smaller wall thickness, and stacking the divided bodies to form the complete body. When the rotating body 51 is formed of the divided bodies in this manner, the wall thickness of the divided body may be made smaller than that of the complete body, and the divided body may be easily manufactured by press work.

Also, as in the first variation illustrated in FIG. 5C, the engaging tooth 51b of the rotating body 51 may be inclined toward one surface side. For example, when the height of the support portion 22e is larger than the height of the support base 2a (when the pathway of the injection body 52a on the side of the support portion 22e is wider than the pathway of the injection body 52a on the support base 2a side), the engaging tooth 51b is inclined toward the support portion 22e side (toward the locking base 22 side). Also, when the height of the support base 2a is larger than the height of the support portion 22e (when the pathway of the injection body 52a on the side of the support base 2a is wider than the pathway of the injection body 52a on the support portion 22e side), the engaging tooth 51b may be inclined toward the support base 2a side (toward the main body side of the spool 2). Meanwhile, in FIG. 5C, a view in an upper stage is a perspective view illustrating a first variation of the rotating body 51, and a view in a lower stage is a side view illustrating the first variation of the rotating body 51.

Also, as in a second variation illustrated in FIG. 5D, the engaging teeth 51b of the rotating body 51 may be alternately inclined toward both the front and rear surface sides. When using the rotating body 51 having such engaging teeth 51b, it is possible to configure such that the support base 2a and the support portion 22e have substantially the same height, that is, the pathway of the injection body 52a on the side of the support base 2a and the pathway of the injection body 52a on the side of the support portion 22e have substantially the same width. Also, angles of inclination of the engaging teeth 51b may be different on both the front and rear surface sides. Meanwhile, in FIG. 5D, a view in an upper stage is a perspective view illustrating the second variation of the rotating body 51, and a view in a lower stage is a side view illustrating the second variation of the rotating body 51.

Although not illustrated, the rotating body 51 may include three types of engaging teeth 51b: the engaging tooth 51b inclined toward the locking base 22 side, the engaging tooth 51b inclined toward the main body side of the spool 2, and the straight engaging tooth 51b not inclined. The rotating body 51 may also include a plurality of engaging teeth 51b having different inclination angles on the same surface side.

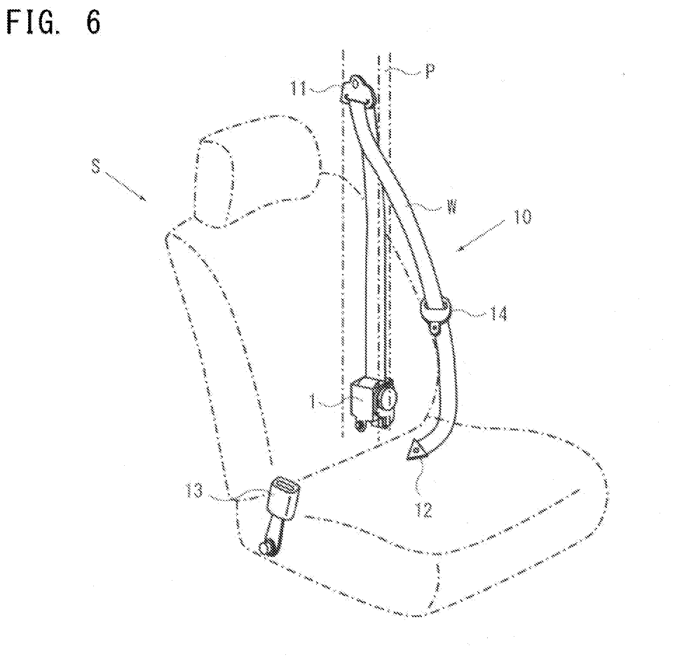

Next, a seat belt device according to the embodiment of the present invention is described. Herein, FIG. 6 is an entire configuration diagram illustrating the seat belt device according to the embodiment of the present invention. Meanwhile, in FIG. 6, for convenience of description, components other than the seat belt device are indicated by dashed-dotted lines.

A seat belt device 10 according to this embodiment illustrated in FIG. 6 is provided with webbing W which restrains an occupant on a seat S, a seat belt retractor 1 which winds up the webbing W, a guide anchor 11 provided on a vehicle body side to guide the webbing W, a belt anchor 12 which fixes the webbing W to the vehicle body side, a buckle 13 arranged on a side surface of the seat S, and a tong 14 arranged on the webbing W; as the seat belt retractor 1, the seat belt retractor 1 according to the above-described first to third embodiments (including variations) is used.

The illustrated seat belt device 10 is a so-called seat belt device for a passenger's seat, and a pillar P is arranged in a position adjacent to the seat S in many cases. For example, the seat belt retractor 1 is arranged in the pillar P, and the guide anchor 11 is arranged on a surface of the pillar P. In such seat belt device 10, the occupant may be restrained on the seat S by the webbing W by withdrawing the webbing W and fitting the tong 14 to the buckle 13.

Meanwhile, since a configuration other than the seat belt retractor 1 of the seat belt device 10 is similar to that of the conventional seat belt device, a detailed description thereof is herein omitted. Also, the seat belt device 10 is not limited to that for a passenger's seat but may be a seat belt device for a driver's seat or a seat belt device for a rear seat. In the seat belt device for a rear seat, the guide anchor 11 may be omitted.

It goes without saying that the present invention is not limited to the above-described embodiments, and may be variously modified without departing from the spirit of the present invention; for example, this may be applied to a seat belt device used for a means of transport other than a vehicle.

### REFERENCE SIGNS LIST

1 Seat belt retractor
2 Spool
2a Support base
2b Auxiliary engaging tooth
3 Base frame
4 Spring unit
5 Pretensioner
6 Lock mechanism
7 Vehicle sensor
10 Seat Belt Device
11 Guide anchor
12 Belt anchor
13 Buckle
14 Tong
21 Torsion bar
22 Locking base
22a Shaft portion
22b Widened portion
22c Rotational shaft
22d Auxiliary engaging tooth
22e Support portion
23 Positioning pin
24 Cap
25 Protect cover
26 Deformation pin
27 Shaft bearing
31, 32 End face
32a Opening
33 Side surface
34 Tie plate
35 Retainer cover
35a Internal tooth
51 Rotating body
51a Opening
51b Engaging tooth
51c Locking hole
52 Power generating unit
52a Injection body
52b Guide pipe
52c Gas generating device
53 Cover member
53a Opening
61 Pawl
62 Lock gear
62a External tooth
62b Cam hole
63 Flywheel
64 Hook Spring
65 Pawl Spring
71 Actuator

1. A seat belt retractor comprising:
a spool which winds up webbing which restrains an occupant;
a pretensioner capable of winding up the webbing in an emergency; and
a lock mechanism capable of stopping withdrawal of the webbing,
wherein the pretensioner includes a rotating body concentrically connected to the spool, and an injection body made of resin which rotates the rotating body, and
the rotating body is made of metal and has a wall thickness half a diameter of the injection body or smaller.

2. The seat belt retractor according to claim 1,
wherein a material of the rotating body is metal containing iron or an alloy thereof.

3. The seat belt retractor according to claim 1,
wherein the spool includes a locking base coupled to the lock mechanism, the rotating body is arranged between the spool and the locking base, and the spool, the locking base, or both of the spool and the locking base includes an auxiliary engaging tooth which assists the rotation of the rotating body.

4. The seat belt retractor according to claim 3,
wherein the spool and the locking base are die cast products.

5. The seat belt retractor according to claim 1,
wherein the spool includes a locking base coupled to the lock mechanism, the rotating body is arranged between the spool and the locking base, one of the spool and the locking base includes an auxiliary engaging tooth which assists the rotation of the rotating body, the other of the spool and the locking base includes a pathway of the injection body, and a lubricant is applied to a surface of the pathway.

6. The seat belt retractor according to claim 1,
wherein the spool includes a locking base coupled to the lock mechanism, the rotating body is arranged between the spool and the locking base and includes a plurality of engaging teeth formed along an outer periphery, and the engaging teeth are inclined toward the spool side or the locking base side.

7. The seat belt retractor according to claim 1,
wherein the spool includes a deformation pin configured to be plastically deformable at the time of rotation when the lock mechanism is in operation, and a head portion of the deformation pin is locked on the rotating body.

8. A seat belt device comprising:
webbing which restrains an occupant;
a seat belt retractor which winds up the webbing;
a belt anchor which fixes the webbing to a vehicle body side;
a buckle arranged on a side surface of the seat; and
a tong arranged on the webbing,
wherein the seat belt retractor is the seat belt retractor according to claim 1.
